(19) United States
(12) Patent Application Publication
(10) Pub. No.: US 2006/0077190 A1
(43) Pub. Date: Apr. 13, 2006

(54) Driving an electrophoretic display

(75) Inventors: Guofu Zhou, Eindhoven (NL); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/542,909

(22) PCT Filed: Jan. 13, 2004
(86) PCT No.: PCT/IB04/50015

§ 371 Date: Jul. 20, 2005

(30) Foreign Application Priority Data
Jan. 23, 2003 (EP) 03100133.2
May 27, 2003 (IB) 03/02342
Jul. 14, 2003 (EP) 03102135.5
Jul. 30, 2003 (EP) 03102354.2

(51) Int. Cl. G09G 5/00

(52) U.S. Cl. 345/204

(57) ABSTRACT

In a method of driving an electrophoretic display, during an image update period (IUi) wherein the pixels (18) of the display are addressed to refresh an image displayed, a chive waveform (DWi) is supplied (10,16) to an associated one of the pixels (18). The drive waveform (DWi) comprises successively a first pulse (Ri, Si) with a first voltage level (+VM, −VM) and a drive pulse (Di) with second voltage level (VDi). The drive pulse (Di) has a variable voltage level to allow obtaining a desired intermediate optical state of the pixel (18) with a high accuracy. An absolute value of the second voltage level (VDi) of the drive pulse (Di) is smaller than an absolute value of the first voltage level (+VM, −VM) of the first pulse (Ri, Si), to minimize the total image update time.

The invention relates to a drive circuit for driving an electrophoretic display, an integrated circuit comprising such a drive circuit, a display apparatus comprising an electrophoretic display and such a drive circuit as claimed in claim 1, and a method of driving an electrophoretic display.

A display device of the type mentioned in the opening paragraph is known from international patent application WO 99/53373. This patent application discloses an electronic ink display which comprises two substrates, one of which is transparent, the other substrate is provided with electrodes arranged in rows and columns. Display elements or pixels are associated with intersections of the row and column electrodes. Each display element is coupled to the column electrode via a main electrode of a thin-film transistor (further referred to as TFT). A gate of the TFT is coupled to the row electrode. This arrangement of display elements, TFT's and row and column electrodes jointly forms an active matrix display device.

Each pixel comprises a pixel electrode which is the electrode of the pixel which is connected via the TFT to the column electrodes. During an image update period or image refresh period, a row driver is controlled to select all the rows of display elements one by one, and the column driver is controlled to supply data signals in parallel to the selected row of display elements via the column electrodes and the TFT's. The data signals correspond to image data to be displayed.

Furthermore, an electronic ink is provided between the pixel electrode and a common electrode provided on the transparent substrate. The electronic ink is thus sandwiched between the common electrode and the pixel electrodes. The electronic ink comprises multiple microcapsules of about 10 to 50 microns. Each microcapsule comprises positively charged white particles and negatively charged black particles suspended in a fluid. When a positive voltage is applied to the pixel electrode with respect to the common electrode, the white particles move to the side of the microcapsule directed to the transparent substrate and the display element appears white to a viewer. Simultaneously, the black particles move to the pixel electrode at the opposite side of the microcapsule where they are hidden from the viewer. By applying a negative voltage to the pixel electrode with respect to the common electrode, the black particles move to the common electrode at the side of the microcapsule directed to the transparent substrate, and the display element appears dark to a viewer. When the electric field is removed, the display device remains in the acquired state and exhibits a bi-stable character. This electronic ink display with its black and white particles is particularly useful as an electronic book.

Grey scales can be created in the display device by controlling the amount of particles that move to the common electrode at the top of the microcapsules. For example, the energy of the positive or negative electric field, defined as the product of field strength and time of application, controls the amount of particles which move to the top of the microcapsules.

The non-pre-published European patent applications PHNL020441 and PHNL030091, which have been filed as European Patent Applications 02077017.8 and 03100133.2, disclose to minimize the image retention by using preset pulses (also referred to as the shaking pulse). Preferably, the shaking pulse comprises a series of AC-pulses, however, the shaking pulse may comprise a single preset pulse only. The non-pre-published patent applications are directed to the use of shaking pulses, either directly before the drive pulses, or directly before the reset pulses. PHN020091 further discloses that the picture quality can be improved by extending the duration of the reset pulse which is applied before the drive pulse. An over-reset pulse is added to the reset pulse, the over-reset pulse and the reset pulse together, have an energy which is large than required to bring the pixel into one of two extreme optical states. The duration of the over-reset pulse may depend on the required transition of the optical state. Unless explicitly mentioned, for the sake of simplicity, the term reset pulse may cover both the reset pulse without the over-reset pulse or the combination of the reset pulse and the over-reset pulse. By using the reset pulse, the pixels are first brought into one of two well defined extreme states before the drive pulse changes the optical state of the pixel in accordance with the image to be displayed. This improves the accuracy and reproducibility of the grey levels.

For example, if black and white particles are used, the two limit optical states are black and white. In the limit state black, the black particles are at a position near to the transparent substrate, in the limit state white, the white particles are at a position near to the transparent substrate.

The drive pulse has an energy to change the optical state of the pixel to a desired level which may be in-between the two limit optical states. Also the duration of the drive pulse may depend on the required transition of the optical state.

PHNL030091 discloses in an embodiment that the shaking pulse precedes the reset pulse. Each level (which is one preset pulse) of the shaking pulse has an energy (or a duration if the voltage level is fixed) sufficient to release particles present in one of the extreme positions, but insufficient to enable said particles to reach the other one of the extreme positions. The shaking pulse increases the mobility of the particles such that the reset pulse has an immediate effect. If the shaking pulse comprises more than one preset pulse, each preset pulse has the duration of a level of the shaking pulse. For example, if the shaking pulse has successively a high level, a low level and a high level, this shaking pulse comprises three preset pulses. If the shaking pulse has a single level, only one preset pulse is present. Preferably, the shaking pulse has the same number of preset pulses with the high level and with the low level such that the average voltage of the shaking pulse is zero.

The complete voltage waveform which has to be presented to a pixel during an image update period is referred to as the drive waveform. The drive waveform usually differs for different optical transitions of the pixels.

The driving of the electrophoretic display in accordance with the present invention differs from the driving disclosed in the non-pre-published patent applications in that, during an image update period, the voltage level of the drive pulse has a lower absolute value than the voltage level of other pulses used in a drive waveform.

A first aspect of the invention provides a drive circuit for driving an electrophoretic display as claimed in claim 1. A second aspect of the invention provides an integrated circuit comprising the drive circuit as claimed in claim 12. A third aspect of the invention provides a display apparatus comprising the drive circuit as claimed in claim 16. A fourth aspect of the invention provides a method of driving an electrophoretic display as claimed in claim 17. Advantageous embodiments are defined in the dependent claims.

In accordance with the first aspect of the invention it is possible to obtain more accurate multi-level grey scales with a minimum duration of the image update period. The lower level of the drive pulse allows obtaining more accurate intermediate optical states of the pixel (for example, grey scales if the electrophoretic display comprises black and white particles). However, if the amplitude of the total drive waveform is varied, the duration of the image update period will increase when the level of the drive pulse decreases. The other pulses only will have substantially the same optical effect if their energy stays substantially the same. Thus, a lower level of the other pulses requires a longer duration of these pulses. The minimal duration of the total drive waveform is obtained if only the amplitude of the drive pulse is selected lower while the amplitude of the other pulses of the drive waveform is higher.

The publication “Drive waveforms for active matrix electrophoretic displays”, by Robert Zhener, Karl Amundson, Ara Knaian, Ben Zion, Mark Johnson, Guofu Zhou, SID2003 digest, pages 842-845 discloses that in an electrophoretic display, grey scales are obtained by modulating the pulse width and/or amplitude of a single drive pulse in each image update period wherein the image on the matrix display is refreshed. This prior art does not disclose drive waveforms which comprise other pulses than the single drive pulse.

In an embodiment as claimed in claim 2, the amplitude of the other pulses is kept constant at or close to the highest level possible to obtain the minimal duration of the total drive waveform.

In an embodiment as claimed in claim 3, the voltage level of the drive pulse is controlled to obtain the desired intermediate optical state (for example, a grey level). Preferably, the voltage level of other pulses such as the reset pulse and/or shaking pulse(s) is substantially constant over time and has an as high voltage level as possible. The absolute value of the voltage level of the reset pulse and/or shaking pulse should be higher than the absolute value of the voltage level of the drive pulse.

In an embodiment as claimed in claim 4, the first pulse is a reset pulse with a first voltage level which preferably is constant and which is higher than the second voltage level of the drive pulse which succeeds the reset pulse. The second voltage level is preferably variable. The reset pulse causes the pixel to obtain a well defined initial optical state. The optical transition caused by the drive pulse is better defined because it starts from this well defined initial optical state. Thus, the use of the reset pulse improves the accuracy of the intermediate optical states. The fixed relatively high level of the reset pulse provides a relatively short reset pulse.

In an embodiment as claimed in claim 5, the first pulse is a shaking pulse with a first level, which preferably is constant and which is higher than the second level of the drive pulse which succeeds the shaking pulse. The second voltage level is preferably variable. The shaking pulse shakes the particles of an EInk electrophoretic display such that they do not stick at a particular position and the effect of the drive pulse is more accurate. The relatively high levels of the preset pulses of the shaking pulse provide a relatively short shaking pulse.

In an embodiment as claimed in claim 6, the further reset pulse is used to improve the DC-balancing of the energy over the pixel. The energy of the voltage pulse is the level of the voltage pulse multiplied by the duration of the voltage pulse. Preferably, the further reset pulse has an energy compensating the energy of a preceding drive pulse.

In an embodiment as claimed in claim 7, the drive waveform comprises a shaking pulse preceding the reset pulse. The shaking pulse reduces the dwell time and the influence of the image retention.

In an embodiment as claimed in claim 8, the drive waveform comprises a shaking pulse preceding the further reset pulse. Again, the shaking pulse reduces the dwell time and the influence of the image retention.

In an embodiment as claimed in claim 9, the drive waveform comprises a shaking pulse in-between the reset pulse and the drive pulse. The shaking pulse reduces the dwell time and the influence of the image retention.

In an embodiment as claimed in claim 10, the drive waveform comprises a shaking pulse in-between the first mentioned reset pulse and the drive pulse. Again, the shaking pulse reduces the dwell time and the influence of the image retention.

In an embodiment as claimed in claim 11, the drive waveform comprises a reset pulse which has a prolonged duration and which is referred to as an over-reset pulse. Such an over-reset pulse has a duration longer than required to change the optical state of the at least one pixel from the present optical state to one of the two extreme optical states of the pixel. If is referred to reset pulse, this includes the possibility that the reset pulse has the prolonged duration.

In a second aspect of the invention, the integrated circuit has a power supply input. The power supply voltage at this power supply input is used to generate the voltage levels of the first pulse.

In an embodiment of the invention as claimed in claim 13, the driver of the integrated circuit controls the level of the drive pulse to obtain the desired optical state of the pixel. This variable level of the drive pulse improves the accuracy of the intermediate optical states of the pixels.

In an embodiment of the invention as claimed in claim 14, the integrated circuit has two power supply inputs which receive different power supply voltages. The lowest power supply voltage is used to generate the drive pulses, the other power supply voltage is used to generate the other pulses.

These and other aspects of the invention are apparent from and will be elucidated with reference to the embodiments described hereinafter.

In the drawings:

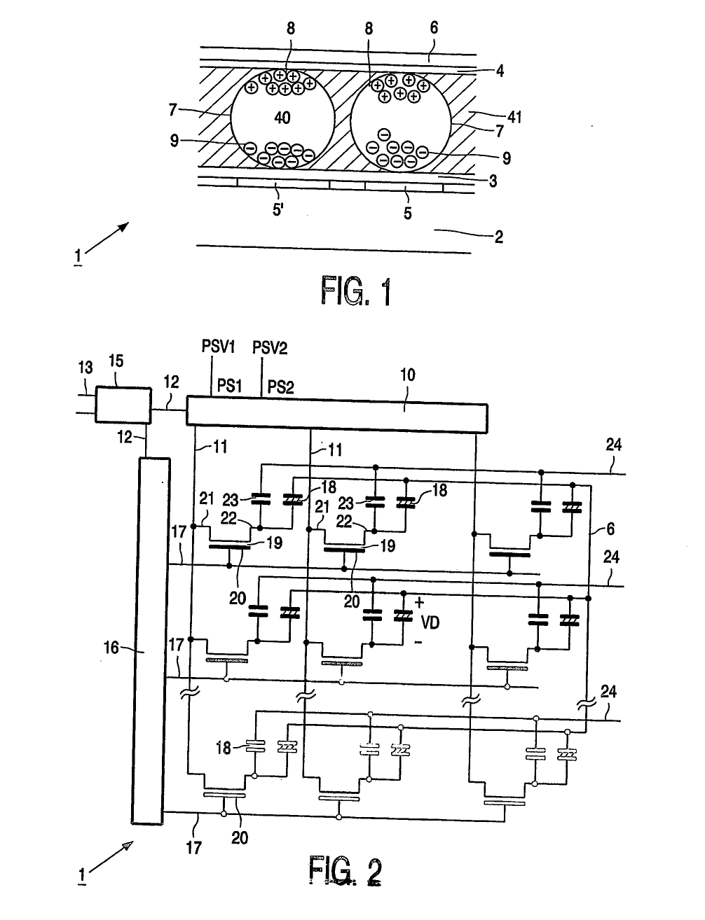

FIG. 1 shows diagrammatically a cross-section of a portion of an electrophoretic display,

FIG. 2 shows diagrammatically a picture display apparatus with an equivalent circuit diagram of a portion of the electrophoretic display,

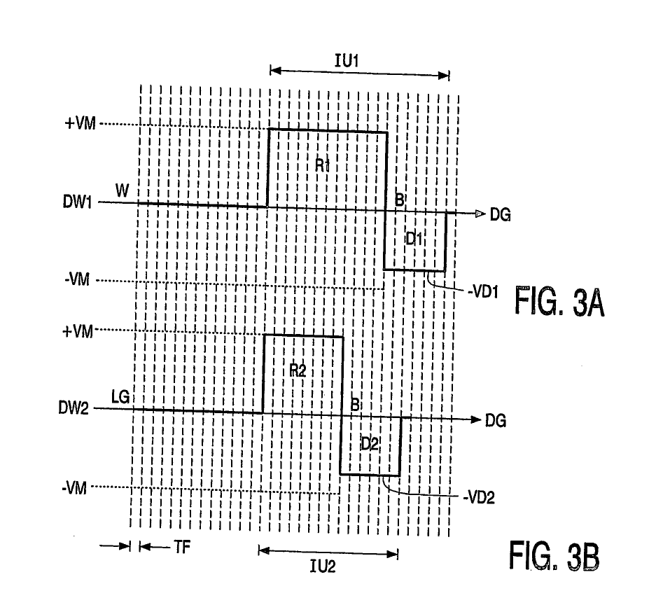

FIG. 3 shows drive waveforms comprising a reset pulse with a fixed level and a drive pulse with a variable level,

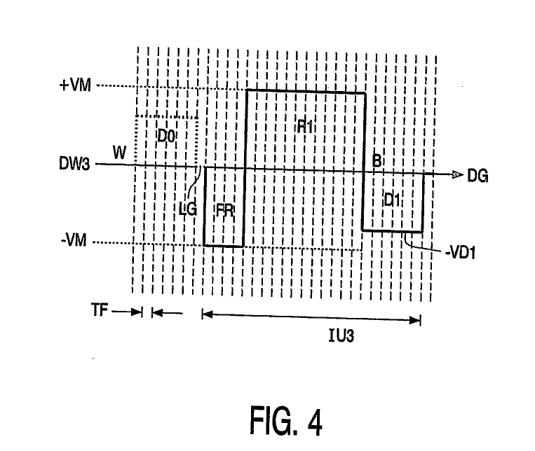

FIG. 4 shows a drive waveform comprising successively a first reset pulse and a second reset pulse, both with a fixed level, and a drive pulse with a variable level,

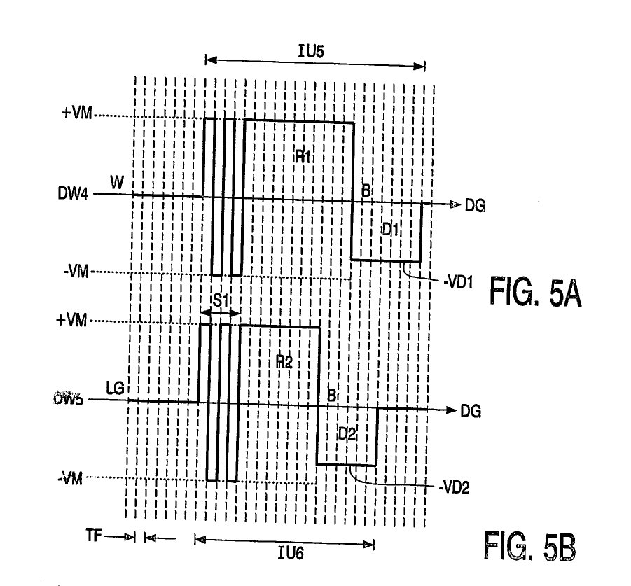

FIG. 5 shows drive waveforms comprising successively a shaking pulse and a reset pulse, both with a fixed level, and a drive pulse with a variable level,

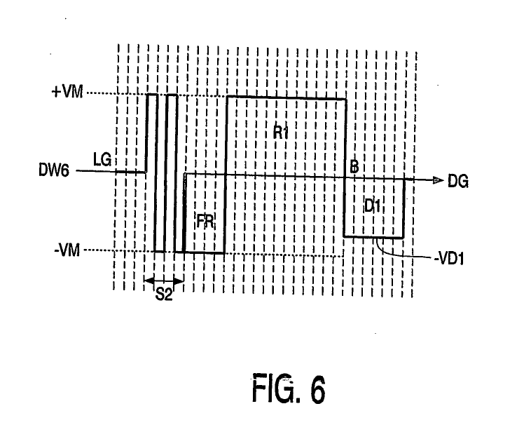

FIG. 6 shows a drive waveform comprising successively a shaking pulse, a first reset pulse and a second reset pulse, all with a fixed level, and a drive pulse with a variable level, and

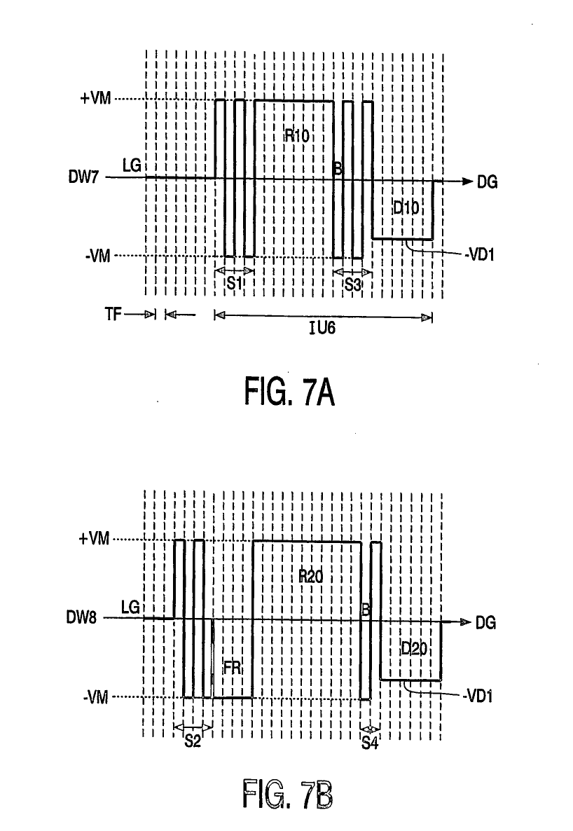

FIG. 7 shows drive waveforms comprising a first shaking pulse preceding the reset pulse or the reset pulses, and a second shaking pulse preceding the drive pulse which is the only pulse with a variable level.

The index i is used to indicate one particular element if several are present or used. For example the drive waveform DWi refers to any of the drive waveforms. On the other hand, DWi refers to a particular one of the drive waveforms DWi. The same references in different Figures refer to the same items.

FIG. 1 shows diagrammatically a cross-section of a portion of an electrophoretic display, which for example, to increase clarity, has the size of a few display elements only. The electrophoretic display comprises a base substrate 2, an electrophoretic film with an electronic ink which is present between two transparent substrates 3 and 4 which, for example, are of polyethylene. One of the substrates 3 is provided with transparent pixel electrodes 5, 5′ and the other substrate 4 with a transparent counter electrode 6. The counter electrode 6 may also be segmented. The electronic ink comprises multiple microcapsules 7 of about 10 to 50 microns. Each microcapsule 7 comprises positively charged white particles 8 and negatively charged black particles 9 suspended in a fluid 40. The dashed material 41 is a polymer binder. The layer 3 is not necessary, or could be a glue layer. When the pixel voltage VD across the pixel 18 (see FIG. 2) is supplied as a positive drive voltage to the pixel electrodes 5, 5′ with respect to the counter electrode 6, an electric field is generated which moves the white particles 8 to the side of the microcapsule 7 directed to the counter electrode 6 and the display element will appear white to a viewer. Simultaneously, the black particles 9 move to the opposite side of the microcapsule 7 where they are hidden from the viewer. By applying a negative drive voltage Vdr between the pixel electrodes 5, 5′ and the counter electrode 6, the black particles 9 move to the side of the microcapsule 7 directed to the counter electrode 6, and the display element will appear dark to a viewer (not shown). When the electric field is removed, the particles 8, 9 remain in the acquired state and the display exhibits a bi-stable character and consumes substantially no power. Electrophoretic media are known per se from e.g. U.S. Pat. No. 5,961,804, U.S. Pat. No. 6,1120,839 and U.S. Pat. No. 6,130,774 and may be obtained from E-ink Corporation.

FIG. 2 shows diagrammatically a picture display apparatus with an equivalent circuit diagram of a portion of the electrophoretic display. The picture display device 1 comprises an electrophoretic film laminated on the base substrate 2 provided with active switching elements 19, a row driver 16 and a column driver 10. Preferably, the counter electrode 6 is provided on the film comprising the encapsulated electrophoretic ink, but, the counter electrode 6 could be alternatively provided on a base substrate if a display operates based on using in-plane electric fields. Usually, the active switching elements 19 are thin-film transistors TFT. The display device 1 comprises a matrix of display elements associated with intersections of row or select electrodes 17 and column or data electrodes 11. The row driver 16 consecutively selects the row electrodes 17, while the column driver 10 provides data signals in parallel to the column electrodes 11 to the pixels associated with the selected row electrode 17. Preferably, a processor 15 firstly processes incoming data 13 into the data signals to be supplied by the column electrodes 11.

The drive lines 12 carry signals which control the mutual synchronisation between the column driver 10 and the row driver 16

The row driver 16 supplies an appropriate select pulse to the gates of the TFT'S 19 which are connected to the particular row electrode 17 to obtain a low impedance main current path of the associated TFT's 19. The gates of the TFT's 19 which are connected to the other row electrodes 17 receive a voltage such that their main current paths have a high impedance. The low impedance between the source electrodes 21 and the drain electrodes of the TFT's allows the data voltages present at the column electrodes 11 to be supplied to the drain electrodes which are connected to the pixel electrodes 22 of the pixels 18. In this manner, a data signal present at the column electrode 11 is transferred to the pixel electrode 22 of the pixel or display element 18 coupled to the drain electrode of the TFT if the TFT is selected by an appropriate level on its gate. In the embodiment shown, the display device of FIG. 1 also comprises an additional capacitor 23 at the location of each display element 18. This additional capacitor 23 is connected between the pixel electrode 22 and one or more storage capacitor lines 24. Instead of TFTs, other switching elements can be used, such as diodes, MIMs, etc. The data signals are defined by the drive waveforms.

The data driver 10 may have two power supply inputs PS1 and PS2 to receive two different power supply voltages PSV1 and PSV2, respectively. The lowest power supply voltage is used to generate the, preferably variable level, drive pulse Di and the highest power supply is used to generate the, preferably constant level, other pulses REi, SPi.

FIG. 3 shows drive waveforms comprising a reset pulse with a fixed level and a drive pulse with a variable level.

FIG. 3A shows a drive waveform DW1 which changes the optical state of a pixel 18 from white W to dark grey DG during an image update period IU1 which, in this example lasts 18 frame periods TF. The drive waveform DW1 comprises during the image update period IU1 a reset pulse R1 preceding a drive pulse D1. The reset pulse has the fixed level +VM, while the drive pulse has the variable level −VD1. The absolute value of the variable level −VD1 is smaller than the fixed level +VM. The actual level of the variable level −VD1 depends on the intermediate optical state which should be reached.

FIG. 3B shows a drive waveform DW2 which changes the optical state of a pixel 18 from light grey LG to dark grey DG during an image update period IU2 which, in this example lasts 14 frame periods TF. The drive waveform DW2 comprises during the image update period IU2 a reset pulse R preceding a drive pulse D2. The reset pulse has the fixed level +VM, while the drive pulse has the variable level −VD2. The absolute value of the variable level −VD2 is smaller than the fixed level +VM.

These driving schemes are referred to as rail stabilized grey scale driving. The particles of the electrophoretic display are always first directed to one of the two extreme states (black B or white W if the electrophoretic display comprises black and white particles) by the reset pulse R1 or R2 before the desired grey level is obtained with the drive pulse D1 or D2. In the example shown, the reset pulse R1 or R2 changes the optical state of the pixel 18 to black B. The variable level −VD1, −VD2 of the drive pulse provides accurate intermediate levels. The fixed higher level +VM provides an as short image update period IU1, IU2 as possible. If both the level of the drive pulses D1, D2 and the reset pulses R1, R2 are variable, at low level drive pulses D1, D2, the reset pulses R1, R2 would have to become relatively long. Consequently, the image update periods IU1, IU2 would become relatively long and the display would have a relatively low refresh rate.

FIG. 4 shows a drive waveform comprising successively a first reset pulse and a second reset pulse, both with a fixed level, and a drive pulse with a variable level. The drive waveform DW3 which occurs during the image update period IU3 is based on the drive waveform shown in FIG. 3A, wherein a further reset pulse FR now precedes the sequence of the reset pulse R1 and the drive pulse D1.

In this driving scheme, the electrophoretic material is always pulled back to its closest rail. In the example shown, the drive pulse D0 which precedes the reset pulse FR belongs to a previous image update period. This drive pulse D0 caused the optical state to change from white W to light grey LG. The reset pulse FR has a fixed negative level −VM to change the optical state of the pixel 18 to the closest rail which is white W for light grey LG. The second reset pulse R1 changes the optical state of the pixel 18 to the other rail (extreme optical state) which is black B. The drive pulse D1 again changes the optical state of the pixel 18 from the extreme optical state black B into the desired dark grey DG optical state.

All grey levels are realized starting from the same extreme optical state (which is black B in this example) to obtain a high reproducibility of the grey levels. The negative polarity of the reset pulse FR improves the DC-balance of the driving scheme. Preferably, the total energy in the reset pulse FR is substantially equal to the total energy in the previous driving pulse D0.

Only the drive pulse D1 has a variable level −VD1, the reset pulse FR has a fixed level −VM and the reset pulse R1 has a fixed level +VM. The fixed levels −VM and +VM are selected as high as possible to obtain an as short as possible image update period IU3.

FIG. 5 shows drive waveforms comprising successively a shaking pulse and a reset pulse, both with a fixed level, and a drive pulse with a variable level.

The drive waveform DW4 shown in FIG. 5A is based on the drive waveform DW1 shown in FIG. 3A. The only difference is that the drive waveform DW4 comprises further a shaking pulse S1 which precedes the reset pulse R1. The shaking pulse S1 comprises alternatively pre-pulses with the fixed level +VM and pre-pulses with the fixed level −VM. The energy in each pre-pulse is sufficient to change the optical state of the pixel 18 but is unable to change the optical state from one of the extreme states to the other extreme state. In fact each pre-pulse is able to move the particles 8, 9 over a relatively short distance only. Preferably, the number of pre-pulses with the positive polarity is equal to the number of pre-pulses with the negative polarity such that the average energy of the shaking pulse S1 is zero. Thus, on average, the particles are not moved, but they are in movement. Thus, the shaking pulse S1 shakes the particles such that they are more responsive to the reset pulse R1 which succeeds the shaking pulse S1. Therefore, the shaking pulse S1 reduces the effect of the image history and/or dwell time.

The drive waveform DW5 shown in FIG. 5B is based on the drive waveform DW2 shown in FIG. 3B. The only difference is that now, the drive waveform DW5 comprises further a shaking pulse S1 which precedes the reset pulse R2. The shaking pulse S1 comprises alternatively pre-pulses with the fixed level +VM and pre-pulses with the fixed level −VM. Again, the shaking pulse S1 reduces the effect of the image history and/or dwell time.

FIG. 6 shows a drive waveform comprising successively a shaking pulse, a first reset pulse and a second reset pulse, all with a fixed level, and a drive pulse with a variable level.

The drive waveform DW6 shown in FIG. 6 is based on the drive waveform DW3 shown in FIG. 4. The only difference is that the drive waveform DW6 comprises further a shaking pulse S2 which precedes the reset pulse FR. The shaking pulse S2 comprises alternatively pre-pulses with the fixed level +VM and pre-pulses with the fixed level −VM. The shaking pulse S2 reduces the effect of the image history and/or dwell time.

FIG. 7 shows drive waveforms comprising a first shaking pulse preceding the reset pulse or the reset pulses, and a second shaking pulse preceding the drive pulse which is the only pulse with a variable level.

The waveform DW7 shown in FIG. 7A is based on the waveform DW5 shown in FIG. 5B. Now, a second shaking pulse S3 is added in-between the reset pulse R10 and the drive pulse D10. Also the shaking pulse S3 comprises alternatively pre-pulses with the fixed level +VM and pre-pulses with the fixed level −VM. The shaking pulses S3 further reduce the effect of the image history and/or dwell time.

The waveform DW7 shown in FIG. 7B is based on the waveform DW6 shown in FIG. 6. Now, a shaking pulse S4 is added in-between the reset pulse R20 and the drive pulse D20. The shaking pulse S4 comprise alternatively pre-pulses with the fixed level +VM and pre-pulses with the fixed level −VM. The shaking pulse S4 further reduces the effect of the image history and/or dwell time.

The driving schemes in accordance with the invention are based on known driving schemes and require the same select driver 16 and data driver 10. The data driver 10 should be able to supply pulses with a variable amplitude. The control of the select driver 16 and the data driver 10 is largely the same as in known drive schemes. Preferably, during an image update period IUi, the select driver 16 selects the rows of pixels 18 of the matrix display one by one and the data driver 10 supplies the drive waveforms DWi in parallel to the selected row of pixels 18. The drive waveforms DWi may differ for each selected pixel 18 depending on the optical transition to be made. The drive waveforms DWi required may be stored in a table look up memory which may be part of the processor 15. The controller may comprise a processor 15 which determines based on the image information 13 to be displayed which drive waveforms DWi should be supplied by the data driver 10 in parallel to the row of selected pixels 18. Each of the stored drive waveforms DWi comprises information about the voltage levels required during the successive frame periods TF of the image update period IUi during which the drive waveform DWi has to be supplied.

It should be noted that the above-mentioned embodiments illustrate rather than limit the invention, and that those skilled in the art will be able to design many alternative embodiments without departing from the scope of the appended claims.

In the Figures is referred to an electronic ink display which is a special electrophoretic display in which microcapsules comprise oppositely charged white and black particles. Further, for the sake of simplicity, this display is considered to be able to show only the four optical states white W, black B, light grey LG and dark grey DG. However, the invention is suitable to electronic ink displays in which more grey scales are displayed, or in which the particles have other colors than black and white. More in general, the use of drive waveforms DWi which during an image update period ILUi have a drive pulse Di with a variable level −VDi and other pulses Ri, Si with a fixed level +VM, −VM which is higher than the variable level −VDi can be applied to electrophoretic displays in general to obtain accurate intermediate optical levels and short image update periods.

The drive pulses Di may comprise multiple levels.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A drive circuit for driving an electrophoretic display having pixels (18), the drive circuit comprising a driver (10,16) for supplying, during an image update period (IUi) wherein the pixels (18) are addressed to refresh an image displayed, a drive waveform (DWi) to an associated one of the pixels (18), the drive waveform (DWi) comprising successively a first pulse (Ri, Si) with a first voltage level (+VM, −VM), and a drive pulse (Di) having a second voltage level (VDi) to obtain a desired intermediate optical state of the associated one of the pixels (18), an absolute value of the second voltage level (VDi) being smaller than an absolute value of the first voltage level (+VM, −VM).

2. A drive circuit as claimed in claim 1, wherein the driver (10, 16) is arranged for supplying during the image update period (IUi) the drive waveform (DWi) wherein the first voltage level (+VM, −VM) is substantially constant over time.

3. A drive circuit as claimed in claim 1, wherein the driver (10, 16) is arranged for supplying during the image update period (IUi) the drive waveform (DWi) wherein the second voltage level (VDi) has a variable level being controlled to obtain the intermediate optical state.

4. A drive circuit as claimed in claim 1, wherein the driver (10, 16) is arranged for supplying during the image update period (IUi) the drive waveform (DWi) wherein the first pulse is a reset pulse (R1) having an energy for changing a present optical state of the associated one of the pixels (18) to one of two extreme optical states.

5. A drive circuit as claimed in claim 1, wherein the driver (10, 16) is arranged for supplying during the image update period (IUi) the drive waveform (DWi) wherein the first pulse is a shaking pulse (Si) comprising at least one sub-pulse having the first voltage level (+VM, −VM), and having the energy for changing the optical state of the associated one of the pixels (18), the energy being too low to change one of two extreme optical states of the associated one of the pixels (18) to the other extreme optical state.

6. A drive circuit as claimed in claim 4, wherein the driver (10, 16) is arranged for supplying during at least one of the image update periods (IUi) the drive waveform (DWi) further comprising a further reset pulse (FR) preceding the first mentioned reset pulse (R1), and having a polarity opposite to a polarity of the first mentioned reset pulse (R1).

7. A drive circuit as claimed in claim 4, wherein the driver (10, 16) is arranged for supplying during at least one of the image update periods (IUi) the drive waveform (DWi) further comprising a shaking pulse (S1) preceding the reset pulse (R1).

8. A drive circuit as claimed in claim 6, wherein the driver (10, 16) is arranged for supplying during at least one of the image update periods (IUi) the drive waveform (DWi) further comprising a shaking pulse (S2) preceding the further reset pulse (FR).

9. A drive circuit as claimed in claim 4, wherein the driver (10, 16) is arranged for supplying during at least one of the image update periods (IUi) the drive waveform (DWi) further comprising a shaking pulse (S3) in-between the reset pulse (R1) and the drive pulse (D1).

10. A drive circuit as claimed in claim 6, wherein the driver (10, 16) is arranged for supplying during at least one of the image update periods (IUi) the drive waveform (DWi) further comprising a shaking pulse (S4) in-between the first mentioned reset pulse (R1) and the drive pulse (D1).

11. A drive circuit as claimed in claim 4, wherein the driver (10, 16) is arranged for supplying during at least one of the image update periods (IUi) the drive waveform (DWi) wherein the reset pulse (R1) has a duration longer than required to change the optical state of the associated one of the pixels (18) from the present optical state of the pixel (18) to one of the two extreme optical states.

12. An integrated circuit comprising the drive circuit as claimed in claim 1, wherein the integrated circuit comprises a power supply input (PS1) for receiving a power supply voltage (PSV1), the voltage level (+VM, −VM) of the first pulse (Ri, Si) being substantially equal to the power supply voltage (PSV1).

13. An integrated circuit as claimed in claim 12, wherein the second voltage level (VDi) is a variable level, and wherein the integrated circuit comprises the driver (10) for controlling the variable level to obtain the desired intermediate optical state.

14. An integrated circuit as claimed in claim 12, further comprising a further power supply input (PS2) for receiving a further power supply voltage (PSV2), a level of the first mentioned power supply voltage (PSV1) being higher than a level of the further power supply voltage (PSV2), and wherein the integrated circuit comprises the driver (10) for using the first mentioned power supply voltage (PSV1) to generate the first pulse (Ri, Si) and for using the further power supply voltage (PSV2) to generate the drive pulse (Di).

15. An integrated circuit as claimed in claim 12, wherein the power supply input (PS1) is arranged for receiving the power supply voltage (PSV1) being a voltage with the largest absolute value received by the integrated circuit.

16. A display apparatus comprising an electrophoretic display having pixels (18), and a drive circuit as claimed in claim 1.

17. A method of driving an electrophoretic display having pixels (18), the method comprising supplying (10,16), during an image update period (IUi) wherein the pixels (18) are addressed to refresh an image displayed, a drive waveform (DWi) to an associated one of the pixels (18), the drive waveform (DWi) comprising successively a first pulse (Ri, Si) with a first voltage level (+VM, −VM) and a drive pulse (Di) having a second voltage level (VDi) to obtain a desired intermediate optical state of the associated one of the pixels (18), an absolute value of the second voltage level (VDi) being smaller than an absolute value of the first voltage level (+VM, −VM).
